(19) United States
(12) Patent Application Publication
(10) Pub. No.: US 2014/0136324 A1
(43) Pub. Date: May 15, 2014

(54) INTERACTIVE COMMUNICATION RELATED TO USAGE DATA PROGRESSION DATA

(71) Applicant: Milestone Sport Ltd., Ramat Gan (IL)

(72) Inventors: Meir MACHLIN, Tel Aviv (IL); Tzach Aizik GOREN, Herzliya (IL); Jason David KAPLAN, Clarksville, MD (US)

(21) Appl. No.: 14/054,119

(22) Filed: Oct. 15, 2013

Related U.S. Application Data
(60) Provisional application No. 61/725,123, filed on Nov. 12, 2012.

(51) Int. Cl. G06Q 30/02

(52) U.S. Cl. CPC G06Q 30/0255
USPC 705/14.53

(57) ABSTRACT

According to an aspect of the presently disclosed subject matter there is provided a method of interactive communication, comprising: receiving a first usage data communication including user data, a first usage progression data and a product data; processing the first usage data to determine a corresponding first usage state based at least on the first usage progression data and at least one of the user data or the product data; selecting a first action based on the first usage state; providing a first interactive communication to a user that is associated with the first usage data, the first interactive communication can be configured to enable the user to execute the selected first action.

### TECHNOLOGICAL FIELD

This invention relates to interactive communications related to usage progression data.

### BACKGROUND

U.S. Pat. No. 5,948,061 to Merriman, et al. discloses methods and apparatuses for targeting the delivery of advertisements over a network such as the Internet. Statistics are compiled on individual users and networks and the use of the advertisements is tracked to permit targeting of the advertisements of individual users. In response to requests from affiliated sites, an advertising server transmits to people accessing the page of a site an appropriate one of the advertisement based upon profiling of users and networks.

U.S. Pat. No. 8,099,258 to Alten, et al. discloses a sensor authenticated to a garment which transfers information, either wirelessly or wired, to an external data processing device. Such information includes location information, physiometric data of the individual wearing the garment, garment performance and wear data (when the garment is an athletic shoe, for example). The external data processing device can be portable digital media players that are, in turn, in wireless communication with a server computer or other wireless devices.

### GENERAL DESCRIPTION

Many of the functional components of the presently disclosed subject matter can be implemented in various forms, for example, as hardware circuits comprising custom VLSI circuits or gate arrays, or the like, as programmable hardware devices such as FPGAs or the like, or as a software program code stored on an intangible computer readable medium and executable by various processors, and any combination thereof. A specific component of the presently disclosed subject matter can be formed by one particular segment of software code, or by a plurality of segments, which can be joined together and collectively act or behave according to the presently disclosed limitations attributed to the respective component. For example, the component can be distributed over several code segments such as objects, procedures, and functions, and can originate from several programs or program files which operate in conjunction to provide the presently disclosed component.

In a similar manner, a presently disclosed component(s) can be embodied in operational data or operational data can be used by a presently disclosed component(s). By way of example, such operational data can be stored on a tangible computer readable medium. The operational data can be a single data set, or can be an aggregation of data stored at different locations, on different network nodes or on different storage devices.

According to an aspect of the presently disclosed subject matter there is provided a method of interactive communication, comprising: receiving a first usage data communication including user data, a first usage progression data and a product data; processing the first usage data to determine a corresponding first usage state based at least on the first usage progression data and at least one of the user data or the product data; selecting a first action based on the first usage state; providing a first interactive communication to a user that is associated with the first usage data, the first interactive communication can be configured to enable the user to execute the selected first action.

According to examples of the presently disclosed subject matter, the usage progression data can be received from a dedicated device which includes a sensor, and wherein the dedicated device can be configured to generate usage progression data based on an activity that is carried out by the user.

According to examples of the presently disclosed subject matter, the method can further include: receiving a second usage data communication including the user data, a second usage progression data and the product data; processing the second usage data to determine a corresponding second updated usage state based at least on the second usage progression data and at least one of the user data or the product data, where the second usage state is different from the first usage state; selecting a second action based on the second usage state, where the second action is different from the first action; providing a second interactive communication to a user that is associated with the second usage data, the second interactive communication enabling the user to execute the second selected action.

According to examples of the presently disclosed subject matter, selecting a first action comprises searching for an item having a characteristic that is associated with at least one of the user data or the product data, and wherein the first action is an action with respect to the selected item.

According to examples of the presently disclosed subject matter, the first usage progression data can be associated with a physical activity, and wherein receiving a first usage data comprises obtaining the first usage progression data from a sensor that is configured to measure a usage parameter that is related to the physical activity.

According to examples of the presently disclosed subject matter, the method can further include providing retailer data related to at least one of the user data, the first usage progression data or the product data, and wherein said processing the first usage data is further based on the retailer data.

According to examples of the presently disclosed subject matter, searching for an item is carried out within a retailer database, and wherein the first action is an action with respect to an item in the retailer database.

According to examples of the presently disclosed subject matter, the method can further include: receiving community data, wherein the community data relates to a community which a user that is associated with the first usage data is a member of, and wherein processing comprises processing the first usage data and the community data, and the first usage state is based on the community data, the first usage progression data and at least one of the user data or the product data.

According to examples of the presently disclosed subject matter, the method can further include: receiving community data, wherein the community data relates to a community which a user that is associated with the first usage data is a member of, and wherein selecting a first action comprises selecting a first action based on the first usage state and the community data.

According to examples of the presently disclosed subject matter, the selected first action can be configured to provide, when executed, a financial incentive for the user to complete a transaction with respect to the selected item.

According to examples of the presently disclosed subject matter, the first action can selected further based on loyalty club data and/or based on an incentive club data.

According to a further aspect of the presently disclosed subject matter there is provided a system for providing interactive communication. According to examples of the presently disclosed subject matter, the system can include: an interface for receiving from a remote device a first usage data communication including: user data, a first usage progression data and a product data; a usage state classifier which can be configured to provide a usage state based at least on a usage progression data and at least one of a user data or a product data; a processing unit configured to obtain a first usage state from the usage state classifier based at least on the first usage progression data and at least one of the user data or the product data; the processing unit can be configured to select a first action based on the first usage state; and the processing unit can be configured to generate a first interactive communication to a user that is associated with the first usage data, the first interactive communication enabling the user to execute the selected first action.

According to examples of the presently disclosed subject matter, the usage progression data can be received from a dedicated device which includes a sensor, and wherein the dedicated device can be configured to generate usage progression data based on an activity that is carried out by the user.

According to examples of the presently disclosed subject matter, the first usage data communication can be part of a batch that includes a plurality of usage data communications and wherein the batch of usage data communications are fed to the processor substantially concurrently, to provide substantially concurrently a corresponding plurality of actions for enabling provisioning of a corresponding plurality of interactive communications, wherein each one of the plurality of interactive communications which is provisioned can be associated with a respective one of the plurality of usage data communications, and each one of the plurality of interactive communications can be configured to enable a respective user to execute the respective action that was provided in association with the respective usage data communication.

According to examples of the presently disclosed subject matter, the usage state classifier and the processing unit can reside on different computers.

According to examples of the presently disclosed subject matter, the usage state classifier can be operated under control of a retailer or a manufacturer of a product with which the product data is associated, and wherein the processing unit can be operated under control of a service provider who provides, inter-alia, interactive communication generation process to the retailer or to the manufacturer of the product with which the product data is associated.

According to examples of the presently disclosed subject matter, the usage state classifier can be operated under control of users including a user with which the user data can be associated, and wherein the processing unit can be operated under control of a service provider which provides, inter-alia, interactive communication generation process to the users.

According to examples of the presently disclosed subject matter, the interface can be configured to receive a second usage data communication including the user data, a second usage progression data and the product data, and the processing unit can be configured to obtain a second updated usage state based at least on the second usage progression data and at least one of the user data or the product data, where the second usage state can be different from the first usage state, and the processing unit can be configured to select a second action based on the second usage state, where the second action can be different from the first action, and the processing unit can be configured to provide a second interactive communication to the user that is associated with the second usage data, the second interactive communication enabling the user to execute the second selected action.

According to examples of the presently disclosed subject matter, the processing unit can be configured to search for an item which has a characteristic that can be associated with at least one of the user data or the product data, and wherein the first action can be an action with respect to the selected item.

According to examples of the presently disclosed subject matter, the system can further include a sensor, and the sensor can be configured to measure a physical activity parameter that is related to a physical activity of a user, and wherein the first usage progression data can be associated with the physical activity parameter, and can be obtained, directly or indirectly from the sensor.

According to examples of the presently disclosed subject matter, the system can include a plurality of sensors, wherein each one of the plurality of sensors can be configured to measure a different physical activity parameter that is related to a physical activity of a user, giving rise to a plurality of physical activity parameters, and wherein at least some of the plurality of sensors are associated with different users and/or with different products, such that the plurality of physical activity parameters are associated with a plurality of different user data and/or with a plurality of different product data, and wherein the plurality of usage data communications are associated with a plurality of physical activity parameters from at least some of the plurality of sensors and with respective user data and product data.

According to examples of the presently disclosed subject matter, the interface can be further configured to receive retailer data related to at least one of the user data, the first usage progression data or the product data, and wherein the usage state classifier is configured to provide the usage state further based on the retailer data.

According to examples of the presently disclosed subject matter, the processing unit can be configured to search for an item which has a characteristic that is associated with at least one of the user data or the product data in a retailer database, and wherein the first action can be an action with respect to the item in the retailer database.

A further aspect of the presently disclosed subject matter relates to a computer program product comprising a computer useable medium having computer readable program code embodied therein of interactive communication, the computer program product comprising: computer readable program code for causing the computer to receive a first usage data communication including user data, a first usage progression data and a product data; computer readable program code for causing the computer to process the first usage data to determine a corresponding first usage state based at least on the first usage progression data and at least one of the user data or the product data; computer readable program code for causing the computer to select a first action based on the first usage state; computer readable program code for causing the computer to provide a first interactive communication to a user that is associated with the first usage data, the first interactive communication enabling the user to execute the selected first action.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 is a block diagram illustration of a system for providing interactive communication, according to examples of the presently disclosed subject matter;

FIG. 2 is a flowchart illustration of a method of interactive communication, according to examples of the presently disclosed subject matter;

FIG. 3 shows a table that illustrates a data structure that can be used in the process of generating according to examples of the presently disclosed subject matter; and

FIG. 4 shows an additional examples of a data structure that can be used in the process of generating according to examples of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without some of these specific details. In other instances, well-known methods, procedures and components have not been described in detail so as not to obscure the presently disclosed subject matter.

Unless specifically stated otherwise, as apparent from the following discussions, it is appreciated that throughout the specification various functional terms refer to the action and/or processes of a computer or computing device, or similar electronic computing device, that manipulate and/or transform data represented as physical, such as electronic, quantities within the computing device's registers and/or memories into other data similarly represented as physical quantities within the computing device's memories, registers or other such tangible information storage, transmission or display devices.

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

As used herein, the terms “example”, “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It would be appreciated that in the present disclosure, and in the claims the designation of a certain data item, such as a usage data, a usage state, a usage progression data, an action, an interactive communication etc. as being “first”, “second” or “n-th” is merely intended to differentiate among different data items of the same kind or type, and is not intended to refer to any specific data item, nor to the order by which the respective data items are received processed and communicated, unless a different meaning is reasonably required or otherwise appears from the context.

The references cited in the background teach many principles of measuring usage progression data that are applicable to the presently disclosed subject matter. Therefore the full contents of these publications are incorporated by reference herein where appropriate for appropriate teachings of additional or alternative details, features and/or technical background.

The operations in accordance with the teachings herein may be performed by a computer specially constructed for the desired purposes or by a general purpose computer specially configured for the desired purpose by a computer program stored in a non-transitory computer readable storage medium. According to examples of the presently disclosed subject matter, a computer that is used to carry out the operations described disclosed herein can be a distributed and a management layer can be implement to management the distributed components of the computer.

Embodiments of the presently disclosed subject matter are not described with reference to any particular programming language. It will be appreciated that a variety of programming languages may be used to implement the teachings of the presently disclosed subject matter as described herein.

Unless specifically stated otherwise, as apparent from the following discussions, it is appreciated that throughout the specification discussions utilizing terms such as “processing”, “calculating”, “computing”, “obtaining”, “determining”, “configuring”, “selecting”, “measuring”, “searching”, “displaying”, “communicating”, “receiving”, “storing” or the like, include actions and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device or a component of an electronic device with data processing capabilities, including, by way of non-limiting example, a Smartphone a Tablet a PC or any other type of device or group of interconnected devices which is/are capable of receiving the types of data set forth herein and which is/are capable of carrying out the operations disclosed herein.

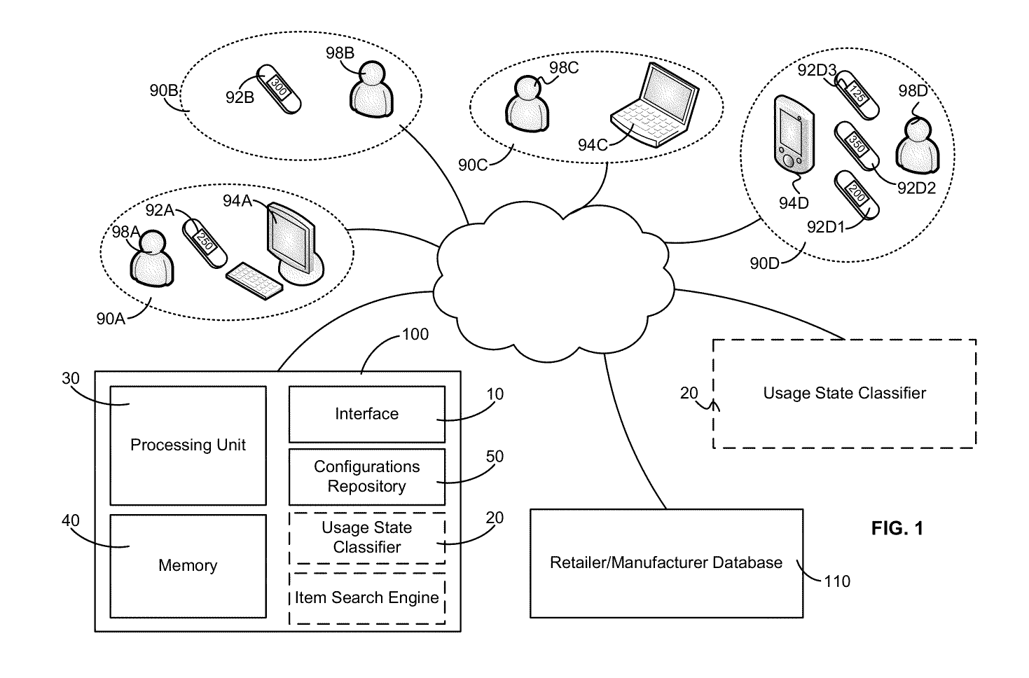

Reference is now made to FIG. 1 which is a block diagram illustration of a system for providing interactive communication, according to examples of the presently disclosed subject matter. According to examples of the presently disclosed subject matter, a system for providing interactive communication 100 can include an interface 10, a usage state classifier 20 and a processing unit 30. In further examples, the system 100 also includes a memory unit 40 and a configurations repository 50. It would be appreciated that the system 10 can include a storage module (not shown) and the configurations repository 50 and possibly other data repositories can be stored on the system's storage module. In further examples, the system 100 or any of its components, including for example any one of the interface 10, the usage state classifier 20, the processing unit 30, the memory unit 40, the configurations repository 50 or the storage module, can be distributed, and the system or one or more of its components can reside on several (e.g., two or more) interconnected nodes.

As part of some examples of the presently disclosed subject matter, the system for providing interactive communication 100 can be associated with one or more data sources. By way of example, and as is shown in FIG. 1, the system can be associated with various types of devices which act as data sources that provide usage data to the system 100.

As part of one example of the presently disclosed subject matter a data source which provides usage data as input to the storage system 100 can be a handheld, mobile or stationary computerized device. By way of non-limiting example, a data source can be a general purpose computerized device, such as a PC, a Laptop, a Tablet or a Smartphone which is configured to receive usage data or/and user data from an external source or sources, including for example a sensor and/or manual input from a user. Examples of the types of data which are included in the usage data are described below.

In a further example of the presently disclosed subject matter, a data source which provides usage data as input to the storage system 100 can be a dedicated device, which is capable of generating the usage data or some part thereof, and is also capable of communicating the usage data to the system 100.

As stated above, the data sources hold usage data, which is provided as input by the system 100. According to examples of the presently disclosed subject matter, the usage data that is input to the storage system can include user data, a user usage progression indication, and a product data.

In FIG. 1, four different examples of data source configurations 90A-90D are illustrated by way of example. In the example of a data source configuration referenced 90A, the data source is a general purpose computerized device 94A (e.g., a PC), and the usage data is provided to the system by the general purpose computerized device 94A. It is noted, that in this configuration 90A at least part of the data which is included in the usage data is provided to the general purpose computerized device 94A by a sensor 92A. Further by way of example, the sensor 92A is configured to generate usage progression data, and the general purpose computerized device 94A receives the usage progression data and generates usage data that includes the usage progression data that was obtained from the sensor 92A. Still further by way of example, the sensor 92A is configured to generate the usage progression data based on an activity that is carried out by user 98A.

In the example of a data source configuration referenced 90B, the data source is a dedicated device 92B, which is capable of generating the usage data or some part thereof, and is also capable of communicating the usage data to the system 100 independently. For example, the dedicated device 92B can include a sensor and other functional components that are configured to generate usage progression data, e.g., based on an activity that is carried out by user 98B, and the dedicated device 92B can further include a communication module and other necessary components, such as an antenna and/or physical interfaces, to enable the dedicated device to communicate with the system 100, and to provide the usage data as input to the system 100. In one example, the dedicated device 92B and the system 100 can be connected via Bluetooth. According to examples of the presently disclosed subject matter, the dedicated device 92B can be configured to communicate specifically with the system 100. For example, the network address of the system 100 can be coded into the program code of the dedicated device 92B. Still further by way of example, the dedicated device 92B can be configured to communicate the usage data routinely, e.g., at predefined intervals, and/or in response to a predefined event, goal or criterion. Still further by way of example, the dedicated device 92B can be configured to generate and communicate the usage data independently of any user interaction with the device 92B, e.g., without requiring the user (e.g., user 98B) to take any direct action, such as instructing the dedicated device 92B to send the usage data to the system 100.

According to examples of the presently disclosed subject matter, the dedicated device 92B can be part of a group of a plurality of dedicated devices (two, three, . . . n devices), where each one of the plurality of dedicated devices is capable of generating usage data, including usage progression data, and each one of the devices is capable of communicating usage data to the system. In still further examples of the presently disclosed subject matter, one of a plurality of dedicated devices can operate as a hub and can be capable of receiving usage data or usage progression data communications from one or more other dedicated devices, and the dedicated device acting as the hub can be capable of relying the usage data or the usage progression data from the other dedicated device(s), to the system, possibly with usage data of its own. In a further example, the dedicated device which acts as a hub can be configured to generate usage data that includes usage progression data from a plurality of sources, e.g., two or more dedicated devices, possibly including usage progression data that was generated by the hub dedicated device itself and usage progression data that was generated by one or more other dedicated devices.

In the example of a data source configuration referenced 90C, the data source is a general purpose computerized device 94C (e.g., a Laptop), and the usage data is provided to the system by the general purpose computerized device 94A, but unlike the example in the configuration 90A, a dedicated device is not involved in generating and/or communicating the usage data. By way of example, at least the usage progression data portion of the usage data can be (synthetically) generated by the general purpose computerized device 94C or fed manually to the general purpose computerized device 94C by a user 98C.

In the example of a data source configuration referenced 90D, the data source is a general purpose computerized device 94D (e.g., a Smartphone), and the usage data is provided to the system by the general purpose computerized device 94D, but here at least the usage progression data portion of the usage data is obtained from a plurality of sensors 92D1-92D3. In one example, the general purpose computerized device 94D can be configured to process the data from the plurality of sensors 92D1-92D3, and the resulting processed data can serve as the usage progression data; or in another example, the include the distinct data from each general one of the plurality of sensors 92D1-92D3 as a distinct data set in the usage progression data portion of the usage data. It would be appreciated that in the later example, each data set in the usage progression data portion of the usage data or have a descriptor or any other sort of indication distinguishes the data set and possible also provides additional information with regard to it, for example, the type of user activity to which the data set relates, the measurement parameter, etc.

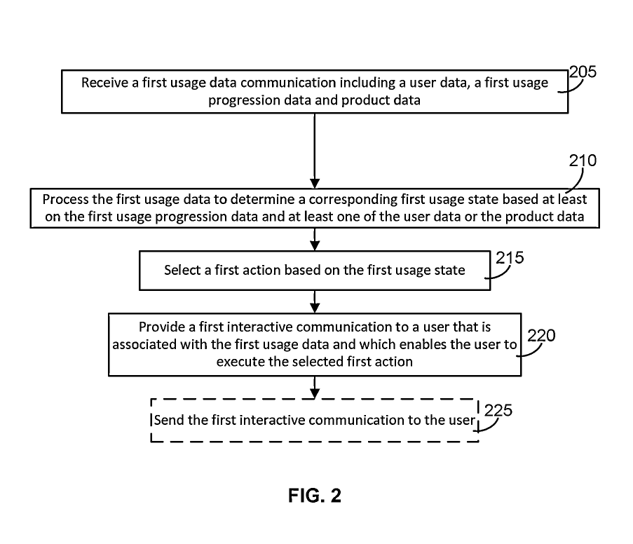

Reference is now additionally made to FIG. 2 which is a flowchart illustration of a method of interactive communication, according to examples of the presently disclosed subject matter. As mentioned above, a usage data communication can be received by the system 100, and the usage data communication can include a user data, a usage progression data and product data (block 205).

The term “user data” as used in the description and in the claims should be interpreted as meaning any data in any format that is indicative of a user which is associated with the respective usage data. According to examples of the presently disclosed subject matter, the user to which the user data relates can be associated with the user to which the usage progression data relates; or in further examples of the presently disclosed subject matter, the user to which the user data relates can be the user to which an interactive communication (generated by the herein disclosed method and system) is to be addressed. Further by way of example, the user to which the usage progression data relates need not necessarily be the same as the user to which the respective interactive communication is addressed, although the addressee can be, but is not necessarily, specified in the usage data communication.

Throughout the description and in the claims the term “user” shall refer to an individual or to a group of individuals and to digital entities (both individual digital entities and a group of individual digital entities), unless a different meaning is reasonably required or otherwise appears from the context. Examples of a user as this term is used herein can refer to a person, a social group, a professional group or any other type of group that includes a plurality of individuals, an email account of such an individual or individuals, a social network account, an avatar, etc.

Throughout the description and in the claims the term “user data” shall refer to data which identifies the user, and possibly also to data which describes the product or certain characteristics or attributes of the user, unless a different meaning is reasonably required or otherwise appears from the context. For example, the user data can simply provide an identification code (e.g., an ID number) of the user, and the system 100 can have all the necessary information relating to the product stored in association with the user's ID number. In a further example, the user data can include a plurality of data items concerning the user including data which can be processed by the system 100 together with the usage progression data. For example the user data can provide the user's age, height, weight, running gait, shoe type, shoe model, shoe size, level of how active is the user, past activates/run history (like: races participated in, pace goals, distance goals), etc. . . .

The term “usage progression data” as used in the description and in the claims should be interpreted as meaning any data in any format which provides an indication regarding a state of some physical characteristic of a product or of an individual or a group of individuals which are using the product at a certain point or over a certain period of time during an activity that involves use of the product, where the effect on the physical characteristic of the product or of the individual(s) which is/are using the product is related to a predefined dynamic aspect of the activity, unless a different meaning is reasonably required or otherwise appears from the context.

By way of example, the physical characteristic to which the usage progression data can relate may include one or more of the following: duration, elasticity, pronation, supination, orientation, posture, resiliency, flexibility, rigidity, dimensions, rate, position of foot when landing, force of impact when landing, etc.

By way of example, the physical characteristic to which the usage progression data relates can be associated with a defined physical characteristic or attribute of a physical object at a certain instant or during certain duration of time. For example the physical characteristic to which the usage progression data relates can include: a compound resilience parameters at a certain instant or an average of the compound resilience of a certain period of time, a compound flexibility or rigidity measure at a certain instant or over a certain period of time, a dimension of a physical object (e.g. thickness of a shoe sole) at a certain instant or over a certain period of time, a durability measure of a certain part of the product to which the usage data relates at a certain instant or over a certain period of time. By way of example, the usage progression data can provide a measure of pronation and supination by a user, and can indicate, in one example, that over time a certain user who bought a stability shoe, is initially not pronating, and the same user, after running 300 Km begins in the stability shoe begins to pronate, and may therefore benefit from a new shoe. In another example, the usage progression data can indicate that a user is landing (during running) on the heels, and when this data is cross-referenced with the product data, which indicates that the user is running in shoes that are suitable for forefoot running, this can be an indication that the shoe may be worn out and needs to be replaced, or is not appropriate for this user.

Further by way of example, the physical characteristic to which the usage progression data relates can be associated with a defined physical characteristic or attribute of a physiological object (e.g., a body organ) at a certain instant or during a certain duration of time. For example the physical characteristic to which the usage progression data relates can include: rate (e.g., heart rate, foot strike rate, etc.), orientation (e.g., foot supination/pronation), posture, force on knee joint or other joints, etc.

Throughout the description and in the claims the term “product” shall refer to a physical object or objects, which over extended use (extended being used here a relative term) is expected to show a modification in some physical attribute thereof, or which over extended use can cause a modification in some physical attribute of another physical object or of a physiological object, unless a different meaning is reasonably required or otherwise appears from the context. By way of example, the modification that is caused by the extended use of the product can be measured and used as the usage progression data. By way of illustration, Examples of products can include: a shoe, a tire, a racquet string, a chain, a brake, a golf club, etc.

Throughout the description and in the claims the term “product data” shall refer to data which identifies the product, and possibly also to data which described the product or certain characteristics or attributes of the product unless a different meaning is reasonably required or otherwise appears from the context. For example, the product data can simply provide an identification code (e.g., GUID) of the product, and the system 100 can have all the necessary information relating to the product stored in association with the product's unique identification code. In a further example, the product data can include a plurality of data items concerning the product including data which can be processed by the system 100 together with the usage progression data. For example, the product data can include: an indication of a type of shoe, a weight of the shoe, a recommended lifespan of the shoe (e.g., in miles), a correction attribute of the shoe.

Returning now to the description of FIG. 2, at block 210 the usage data to determine a corresponding usage state based at least on the usage progression data and at least one of the user data or the product data.

By way of example, upon receive the usage data at the system 100, the processing unit 30, possibly in cooperation with the usage state classifier 20, can be capable of determining the respective usage state based at least on the usage progression data and at least one of the user data or the product data. Still further by way of example, the usage state classifier can include logic, definitions and parameters which are necessary to determine a usage state based at least on the usage progression data and at least one of the user data or the product data.

According to examples of the presently disclosed subject matter, the system 100 can be configured to select with respect to a certain usage data one usage state from a plurality of possible usage states according to a certain relation between the usage progression data and at least one of the user data or the product data that are included in the usage data. In yet further examples of the presently disclosed subject matter, the system 100 can be configured to compute with respect to a certain usage data a usage state from a plurality of possible usage states according to a certain relation between the usage progression data and at least one of the user data or the product data that are included in the usage data.

For example, say that the usage data includes a current distance parameter which refers to the total number of kilometers over which a certain shoe was used, and the product data indicates which shoe was used. Further according to this example, the system 100 obtained data relating to recommended lifespan of the particular shoe that is referenced in the usage data. Further according to this example, say that the system is configured to classify the usage progression data to one of four states (new, within recommended usage range, approaching end of lifespan, worn-out) according to the current number of kilometers over which the (particular) shoe was used, where each one of the four states is associated with a different range of kilometers or miles.

In yet a further example, the same states are used, but the system is further configured to adjust the ranges with which each state is associated, and possibly also change the recommended lifespan of the shoe, based on the user data. For example, for lighter athletes the system can be configured to increase the number of kilometers before transitioning to the next state and also the total number of kilometers before the shoe is considered to be worn out.

In still further examples of the presently disclosed subject matter, the states can be modified according to a combination of collected usage data, such as distance traveled (kilometers/miles), the terrain (road/trail), number of training session during a week, and user data (such as: age, shoe type, etc.).

According to examples of the presently disclosed subject matter, based on the selected or otherwise determined usage state, an action can be selected (block 215), and an interactive communication can be generated which can be provided to a user that is associated with the usage data, and wherein the interactive communication is capable of enabling the user to execute the selected action (block 220). According to examples of the presently disclosed subject matter, the interactive communication can be sent to a user that is associated with first usage data, the first interactive communication enabling the user to execute the selected first action. In some examples of the presently disclosed subject matter, the user to which the interactive communication is addressed is the same user as the user to which the user data relates, however in further examples, it is not necessarily so, and the user data can relate to a user other than the user to which the interactive communication is addressed.

It would be understood that in the description and in the claims the term “action” shall refer to an executable computerized operation, possibly embodied in computer program code, that can be invoked by a user, e.g., by a user to which a respective interactive communication is addressed, and once invoked, the action executes to create an interaction with the user. Thus, in accordance with examples of the presently disclosed subject matter, by providing a user with an interactive communication which was generated according to examples of the presently disclosed subject matter, a relevant interactive and potentially engaging channel can be created with the user, and the system 100 can provide the user with the ability to invoke and execute a certain action which can be matched with an expected current need of the user, as estimated based at least on the respective usage progression data. For example, the action can be configured to provide, when executed, a financial incentive for the user to complete a transaction with respect to a certain item.

For example, say that certain usage data is received at the system. The usage progression data included in the usage data provides a certain distance parameter, and based on the user data and the product data it is determined that the distance parameter relates to a running shoe, and that the running shoe is approaching the end of its lifespan. The usage state that is selected for the usage data is, for example, “replace immediately” (end of lifespan reached), and according to the system configurations, a buy with 20% discount action is selected. Still further by way of example, an interactive communication which enables the user to invoke an online transaction by invoking buy with 20% discount action is generated. For example, the interactive communication can include a link to a certain URL, and the recipient of the interactive communication can invoke the online transaction simply by clicking the link. It would be appreciated that in some cases and according to examples of the presently disclosed subject matter, after clicking the link, the recipient of the interactive communication may be required to take further action in order to complete the transaction.

In yet a further example, according to the usage progression data, the user data and the product data it is determined that a running shoe is new (only a few number of miles were recorded). The usage state that is selected for the usage data is, for example, “offer complementary products”. An interactive communication is then generated according to the selected usage state. For example, as part of generating the interactive communication, the product data and/or the user data can be processed and certain properties, attributes or characteristics of the respective product and/or the respective user can be taken into account when generating the interactive communication. Still further by way of example, there may be various types of usage states, and the generation of the interactive communication can be affected by the type of usage state that was selected. Yet further by way of example, different usage states may involve different properties, attributes or characteristics of the respective product and/or the respective user. Returning now to the above example, based on the processing of the properties, attributes or characteristics of the respective product and/or the respective user, it may be determined that the complementary products are running apparel for men, size L and whose color is bright yellow. The interactive communication can be provided to the user. For example, the interactive communication can include a series of links to several URLs, where each URL link to a certain apparel item that was selected as a complementary product, and the recipient of the interactive communication can invoke an online transaction by clicking any one of links.

In accordance with some examples of the presently disclosed subject matter, a first usage data communication including user data, a first usage progression data and a product data can be received at the system. The first usage data communication can be processed to determine a corresponding first usage state based at least on the first usage progression data and at least one of the user data or the product data, and a first action can be selected based on the first usage state. Next, a first interactive communication can be provided to a user that is associated with the first usage data, where the first interactive communication can be configured to enable the user to execute the selected first action.

Still further by way of example, a second usage data communication including the user data, a second usage progression data and the product data can also be received at the system. Here the product data and the user data are the same as in the case of the first usage data, but the usage progression data is different. The second usage data can also be processed and a corresponding second usage state can be determined based at least on the second usage progression data and at least one of the user data or the product data, where the second usage state is different from the first usage state. Next, a second action can be selected based on the second usage state, where the second action is different from the first action, and a second interactive communication can be provided to a user that is associated with the second usage data, the second interactive communication can be configured to enabling the user to execute the second selected action.

Still further by way of example, the system 100 can be configured to receive and process a plurality of usage data communications in parallel or over a short period of time. In one example, the system 100 can configured to receive a batch of usage data that includes a plurality of usage data communications. The batch of usage data communications can fed to the processor 30 substantially concurrently, to provide substantially concurrently a corresponding plurality of actions for enabling provisioning of a corresponding plurality of interactive communications. Each one of the plurality of interactive communications can be associated with a respective one of the plurality of usage data communications, and each one of the plurality of interactive communications is configured to enable a respective user to execute the respective action that was provided in association with the respective usage data communication

It would be appreciated that in accordance with examples of the presently disclosed subject matter, the usage progression data provides an indication regarding a state of some physical characteristic of a product or of an individual or a group of individuals which are using the product at a certain point or over a certain period of time during an activity that involves use of the product, where the effect on the physical characteristic of the product or of the individual(s) which is/are using the product is related to a predefined dynamic aspect of the activity, and therefore, different usage data can relate to the same product data and the same user data at different times while a product is being used and thus with different usage progression data.

According to examples of the presently disclosed subject matter, the selection of the action (see for example block 215 in FIG. 2) can include searching for an item having a characteristic that is associated with at least one of the user data or the product data. For example, in case the product data indicates that the product is a neutral type running shoe, as part of the selection of the action, a search can be conducted for running shoes that are categorized as neutral. Still further by way of example, the action can be some action with respect to the selected item. Referring to the neutral running shoe example, the action can be some interactive promotion to enable a user to purchase one or more of the neutral running shoes that came up in the search, at a reduced price.

According to examples of the presently disclosed subject matter, the usage progression data can be associated with a physical activity. Still further according to examples of the presently disclosed subject matter, the usage progression data can originate from a sensor that is configured to measure a usage parameter that is related to the physical activity. Reading from the sensor can be obtained from time to time and can be used to generate different usage progression data and respective different usage data. Non-limiting examples of physical activities to which the usage progression data can relate include: running, walking, rowing, cycling, swimming, tennis, ball kicking, martial arts, skateboarding, skiing, snowboarding, etc. . . .

According to further examples of the presently disclosed subject matter, the usage data can further include or be associated with retailer data and/or with manufacturer data. For example, the retailer/manufacturer data can be an independent type of data or can be linked to one of the user data, the first usage progression data or the product data.

Still further by way of example, the operation of selecting a first action (e.g., the operation referenced with block 215 in FIG. 2) can include searching for an item having a characteristic that is associated with at least one of the user data or the product data. Further by way of example, the first action can be an action with respect to the selected item. Yet further by way of example, the search for the item can be carried out within the retailer/manufacturer database. Yet further by way of example, the selected action can be an action with respect to an item in the retailer database.

For example referring back to FIG. 1, the system 100 can be connected to a retailer or manufacturer database 110, for example, through the Internet. Upon receiving usage data the system 100 can be configured to query the remote retailer/manufacturer database 110 and obtain retailer/manufacturer data. For example, the retailer/manufacturer database 110 query can be associated with the product data that was included in the usage data communication. Say that the product data relates to a certain type of running shoe, in this case the query can request to receive entries from the database that relate to this type of running shoe. In a similar manner the query can relates to some property, parameter or attribute that is included or otherwise derived from the user data or the usage progression data, or from any combination of the data that is included in the usage data.

It would be appreciated that in some examples of the presently disclosed subject matter, the retailer/manufacturer database 110 can be implemented as a component of the system 100.

In still further examples of the presently disclosed subject matter, the usage state classifier 20 can be operated under control of a retailer or a manufacturer of a product with which the product data is associated, and the processing unit 30 is operated under control of a service provider which provides, inter-alia, interactive communication generation process to the retailer or to the manufacturer of the product with which the product data is associated.

In yet further examples of the presently disclosed subject matter, the usage state classifier 20 can be operated under control of users including a user with which the user data is associated, and the processing unit 30 can be operated under control of a service provider who provides, inter-alia, interactive communication generation process to the users.

Another type of data that can be received and processed as part of the process of generating the interactive communication which was described above, is community data. The community data can relate to a community, which the user that is associated with the first usage data is a member of. By way of example, the community data can be processed together with the usage data. In yet further examples, the usage state can be determined based on the community data, the first usage progression data and at least one of the user data or the product data. In still a further example, which is used to configure the interaction communication can be selected based on the usage state and based on the community data

Yet another type of data that can be received and processed as part of the process of generating the interactive communication which was described above is loyalty club data and/or incentive club data. The loyalty club data or incentive club data can relate are similar to the community data and can be processed in a similar fashion.

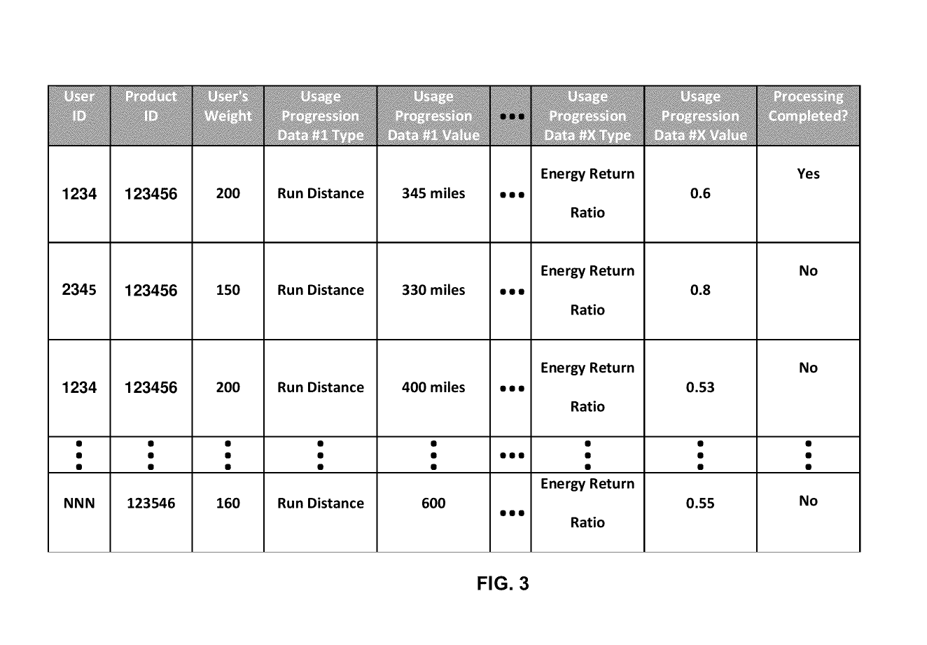

Reference is now made to FIG. 3, which shows a table that illustrates a data structure that can be used in the process of generating according to examples of the presently disclosed subject matter. In the example shown in FIG. 3, the user data that is included in the usage data communications includes a user ID and a user weight. Further by way of example, the product data in the usage data communications includes a product ID. The usage progression data that is included in the usage data communications includes an indication that a first usage progression value relates to run distance, and the corresponding value indicates the distance value, and an indication that an X usage progression value relates to energy return ratio (of the shoe that the user is running with), and the corresponding value indicates the ratio value. The table also includes a flag to indicate whether the processing of the usage data with which each entry is associated was completed or not. By way of example the processing completed state is reached when an interactive communication which corresponds to the usage data was generated and transmitted.

According to examples of the presently disclosed subject matter, and as implied in FIG. 3, there may possibly be additional types of data than those which are shown in FIG. 3, and the data from such other data types can also be stored as part of an entry or entries which are associated with the respective usage data. The additional types of data can be included in the usage data communication, or can be obtained from other sources, including but not limited to data that is prestored and which is determined to be associated with a certain usage data communication.

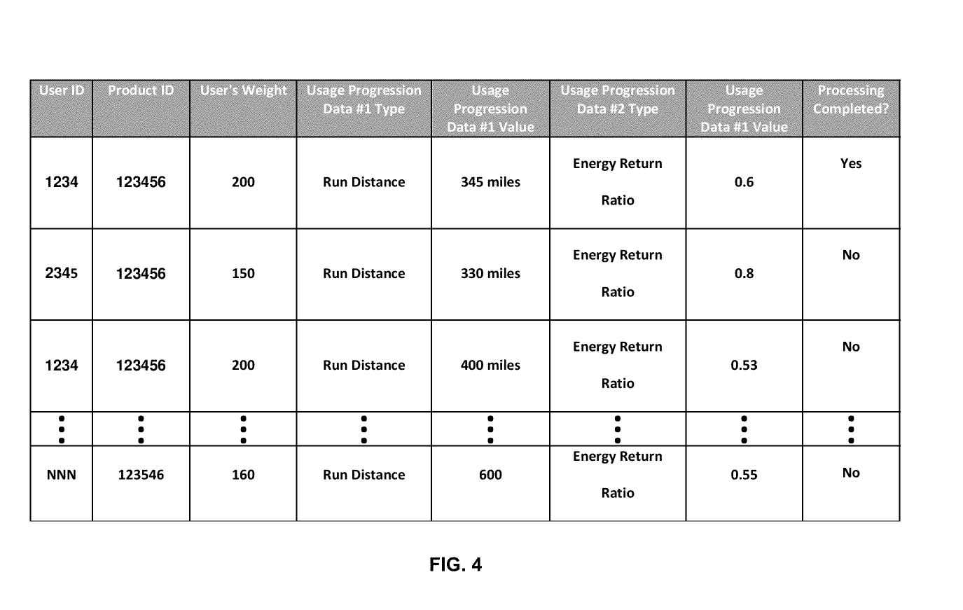

The table in FIG. 4, also illustrates the individuality of the usage progression data, and how it may be related to user data, in this case, and/or to product data, in other cases. For example the user which is associated with the first row and the user which is associated with the second row ran a very similar distance using the same shoe (for example, as indicated by the product ID record in each case), but the energy return ration of the first row runner's shoe is considerably worse, indicating that the show that is associated with the first row is significantly more worn out, at least in terms or energy return. Once possible (but not binding) reason for the differences is the weight of the two users. Clearly the user that is associated with the usage data that is recorded in the second row is considerably lighter than the user that is associated with the usage data that is recorded in the first row. However, there may be other reasons for the difference. The interaction communication can take all of the above, or only some of it, when processing the usage data.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A method of interactive communication, comprising:
receiving a first usage data communication including user data, a first usage progression data and a product data;
processing the first usage data to determine a corresponding first usage state based at least on the first usage progression data and at least one of the user data or the product data;
selecting a first action based on the first usage state;
providing a first interactive communication to a user that is associated with the first usage data, the first interactive communication enabling the user to execute the selected first action.

2. The method according to claim 1, wherein the usage progression data is received from a dedicated device which includes a sensor, and wherein the dedicated device is configured to generate usage progression data based on an activity that is carried out by the user.

3. The method according to claim 1, further comprising:
receiving a second usage data communication including the user data, a second usage progression data and the product data;
processing the second usage data to determine a corresponding second updated usage state based at least on the second usage progression data and at least one of the user data or the product data, where the second usage state is different from the first usage state;
selecting a second action based on the second usage state, where the second action is different from the first action;
providing a second interactive communication to a user that is associated with the second usage data, the second interactive communication enabling the user to execute the second selected action.

4. The method according to claim 1, wherein said selecting a first action comprises searching for an item having a characteristic that is associated with at least one of the user data or the product data, and wherein the first action is an action with respect to the selected item.

5. The method according to claim 1, wherein the first usage progression data is associated with a physical activity, and wherein said receiving a first usage data comprises obtaining the first usage progression data from a sensor that is configured to measure a usage parameter that is related to the physical activity.

6. The method according to claim 1, further comprising providing retailer data related to at least one of the user data, the first usage progression data or the product data, and wherein said processing the first usage data is further based on the retailer data.

7. The method according to claim 4, wherein said searching for an item is carried out within a retailer database, and wherein the first action is an action with respect to an item in the retailer database.

8. The method according to claim 1, further comprising:
receiving community data, wherein the community data relates to a community which a user that is associated with the first usage data is a member of, and
wherein said processing comprises processing the first usage data and the community data, and the first usage state is based on the community data, the first usage progression data and at least one of the user data or the product data.

9. The method according to claim 1, further comprising:
receiving community data, wherein the community data relates to a community which a user that is associated with the first usage data is a member of, and
wherein said selecting a first action comprises selecting a first action based on the first usage state and the community data.

10. The method according to claim 7, wherein the selected first action is configured to provide, when executed, a financial incentive for the user to complete a transaction with respect to the selected item.

11. The method according to claim 1, wherein the first action is selected further based on loyalty club data and/or based on an incentive club data.

12. A system for providing interactive communication, comprising:
an interface for receiving from a remote device a first usage data communication including: user data, a first usage progression data and a product data;
a usage state classifier which is configured to provide a usage state based at least on a usage progression data and at least one of a user data or a product data;
a processing unit configured to obtain a first usage state from the usage state classifier based at least on the first usage progression data and at least one of the user data or the product data;
the processing unit is configured to select a first action based on the first usage state; and
the processing unit is configured to generate a first interactive communication to a user that is associated with the first usage data, the first interactive communication enabling the user to execute the selected first action.

13. The system according to claim 12, wherein the usage progression data is received from a dedicated device which includes a sensor, and wherein the dedicated device is configured to generate usage progression data based on an activity that is carried out by the user.

14. The system according to claim 12, wherein the first usage data communication is part of a batch that includes a plurality of usage data communications and wherein the batch of usage data communications are fed to the processor substantially concurrently, to provide substantially concurrently a corresponding plurality of actions for enabling provisioning of a corresponding plurality of interactive communications, wherein each one of the plurality of interactive communications which is provisioned is associated with a respective one of the plurality of usage data communications, and each one of the plurality of interactive communications is configured to enable a respective user to execute the respective action that was provided in association with the respective usage data communication.

15. The system according to claim 12, wherein the usage state classifier and the processing unit reside on different computers.

16. The system according to claim 14, wherein the usage state classifier is operated under control of a retailer or a manufacturer of a product with which the product data is associated, and wherein the processing unit is operated under control of a service provider who provides, inter-alia, interactive communication generation process to the retailer or to the manufacturer of the product with which the product data is associated.

17. The system according to claim 15, wherein the usage state classifier is operated under control of users including a user with which the user data is associated, and wherein the processing unit is operated under control of a service provider which provides, inter-alia, interactive communication generation process to the users.

18. The system according to claim 12, wherein:
the interface is configured to receive a second usage data communication including the user data, a second usage progression data and the product data, and
wherein the processing unit is configured to obtain a second updated usage state based at least on the second usage progression data and at least one of the user data or the product data, where the second usage state is different from the first usage state, and
wherein the processing unit is configured to select a second action based on the second usage state, where the second action is different from the first action, and
wherein the processing unit is configured to provide a second interactive communication to the user that is associated with the second usage data, the second interactive communication enabling the user to execute the second selected action.

19. The system according to claim 12, wherein the processing unit is configured to search for an item which has a characteristic that is associated with at least one of the user data or the product data, and wherein the first action is an action with respect to the selected item.

20. The system according to claim 12, further comprising a sensor that is configured to measure a physical activity parameter that is related to a physical activity of a user, and wherein the first usage progression data is associated with the physical activity parameter, and is obtained, directly or indirectly from the sensor.

21. The system according to claim 14, further comprising a plurality of sensors, wherein each one of the plurality of sensors is configured to measure a different physical activity parameter that is related to a physical activity of a user, giving rise to a plurality of physical activity parameters, and wherein at least some of the plurality of sensors are associated with different users and/or with different products, such that the plurality of physical activity parameters are associated with a plurality of different user data and/or with a plurality of different product data, and wherein the plurality of usage data communications are associated with a plurality of physical activity parameters from at least some of the plurality of sensors and with respective user data and product data.

22. The system according to claim 12, wherein the interface is further configured to receive retailer data related to at least one of the user data, the first usage progression data or the product data, and wherein the usage state classifier is configured to provide the usage state further based on the retailer data.

23. The system according to claim 19, wherein the processing unit is configured to search for an item which has a characteristic that is associated with at least one of the user data or the product data in a retailer database, and wherein the first action is an action with respect to the item in the retailer database.

24. A computer program product comprising a computer useable medium having computer readable program code embodied therein of interactive communication, the computer program product comprising:
computer readable program code for causing the computer to receive a first usage data communication including user data, a first usage progression data and a product data;
computer readable program code for causing the computer to process the first usage data to determine a corresponding first usage state based at least on the first usage progression data and at least one of the user data or the product data;
computer readable program code for causing the computer to select a first action based on the first usage state;
computer readable program code for causing the computer to provide a first interactive communication to a user that is associated with the first usage data, the first interactive communication enabling the user to execute the selected first action.
